(19) United States
(12) Patent Application Publication
(10) Pub. No.: US 2026/0099768 A1
(43) Pub. Date: Apr. 9, 2026

(54) SCALING MODEL PARAMETERS

(71) Applicant: QUALCOMM Incorporated, San Diego, CA (US)

(72) Inventors: Shuanshuan WU, San Diego, CA (US); Stelios STEFANATOS, San Diego, CA (US); Libin LIU, Monterey Park, CA (US); Arthur GUBESKYS, San Diego, CA (US)

(21) Appl. No.: 19/115,402

(22) PCT Filed: Oct. 11, 2023
(86) PCT No.: PCT/US2023/076539

§ 371 Date: Mar. 26, 2025

(30) Foreign Application Priority Data
Nov. 9, 2022 (GR) 20220100918

(51) Int. Cl. G06N 20/00

(52) U.S. Cl. CPC G06N 20/00

(57) ABSTRACT

Various aspects of the present disclosure generally relate to wireless communication. In some aspects, a user equipment (UE) may obtain information associated with a scaling factor to be applied to a parameter for updating a model. The UE may selectively apply the scaling factor to the parameter, based at least in part on a number of training samples associated with the UE, to obtain a scaled parameter. The UE may transmit the scaled parameter to a network node. Numerous other aspects are described.

### CROSS-REFERENCE TO RELATED APPLICATION

This patent application claims priority to Greek patent application No. 20220100918, filed on Nov. 9, 2022, entitled “SCALING MODEL PARAMETERS.” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for scaling model parameters.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE. NR, and other radio access technologies remain useful.

### SUMMARY

Some aspects described herein relate to a method of wireless communication performed by a user equipment (UE). The method may include obtaining information associated with a scaling factor to be applied to a parameter for updating a model. The method may include selectively applying the scaling factor to the parameter, based at least in part on a number of training samples associated with the UE, to obtain a scaled parameter. The method may include transmitting the scaled parameter to a network node.

Some aspects described herein relate to a method of wireless communication performed by a network node. The method may include transmitting information to a UE that indicates a scaling factor to be applied to a parameter for updating a model based at least in part on a number of training samples associated with the UE. The method may include receiving a scaled parameter from the UE that is based at least in part on the scaling factor and the number of training samples associated with the UE.

Some aspects described herein relate to an apparatus for wireless communication performed by a UE. The apparatus may include a memory and one or more processors, coupled to the memory. The one or more processors may be configured to obtain information associated with a scaling factor to be applied to a parameter for updating a model. The one or more processors may be configured to selectively apply the scaling factor to the parameter, based at least in part on a number of training samples associated with the UE, to obtain a scaled parameter. The one or more processors may be configured to transmit the scaled parameter to a network node.

Some aspects described herein relate to an apparatus for wireless communication performed by a network node. The apparatus may include a memory and one or more processors, coupled to the memory. The one or more processors may be configured to transmit information to a UE that indicates a scaling factor to be applied to a parameter for updating a model based at least in part on a number of training samples associated with the UE. The one or more processors may be configured to receive a scaled parameter from the UE that is based at least in part on the scaling factor and the number of training samples associated with the UE.

Some aspects described herein relate to a non-transitory computer-readable medium that stores a set of instructions for wireless communication by a UE. The set of instructions, when executed by one or more processors of the UE, may cause the UE to obtain information associated with a scaling factor to be applied to a parameter for updating a model. The set of instructions, when executed by one or more processors of the UE, may cause the UE to selectively apply the scaling factor to the parameter, based at least in part on a number of training samples associated with the UE, to obtain a scaled parameter. The set of instructions, when executed by one or more processors of the UE, may cause the UE to transmit the scaled parameter to a network node.

Some aspects described herein relate to a non-transitory computer-readable medium that stores a set of instructions for wireless communication by a network node. The set of instructions, when executed by one or more processors of the network node, may cause the network node to transmit information to a UE that indicates a scaling factor to be applied to a parameter for updating a model based at least in part on a number of training samples associated with the UE. The set of instructions, when executed by one or more processors of the network node, may cause the network node to receive a scaled parameter from the UE that is based at least in part on the scaling factor and the number of training samples associated with the UE.

Some aspects described herein relate to an apparatus for wireless communication. The apparatus may include means for obtaining information associated with a scaling factor to be applied to a parameter for updating a model. The apparatus may include means for selectively applying the scaling factor to the parameter, based at least in part on a number of training samples associated with the UE, to obtain a scaled parameter. The apparatus may include means for transmitting the scaled parameter to a network node.

Some aspects described herein relate to an apparatus for wireless communication. The apparatus may include means for transmitting information to a UE that indicates a scaling factor to be applied to a parameter for updating a model based at least in part on a number of training samples associated with the UE. The apparatus may include means for receiving a scaled parameter from the UE that is based at least in part on the scaling factor and the number of training samples associated with the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example model, in accordance with the present disclosure.

FIG. 5 is a diagram illustrating an example of scaling model parameters, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

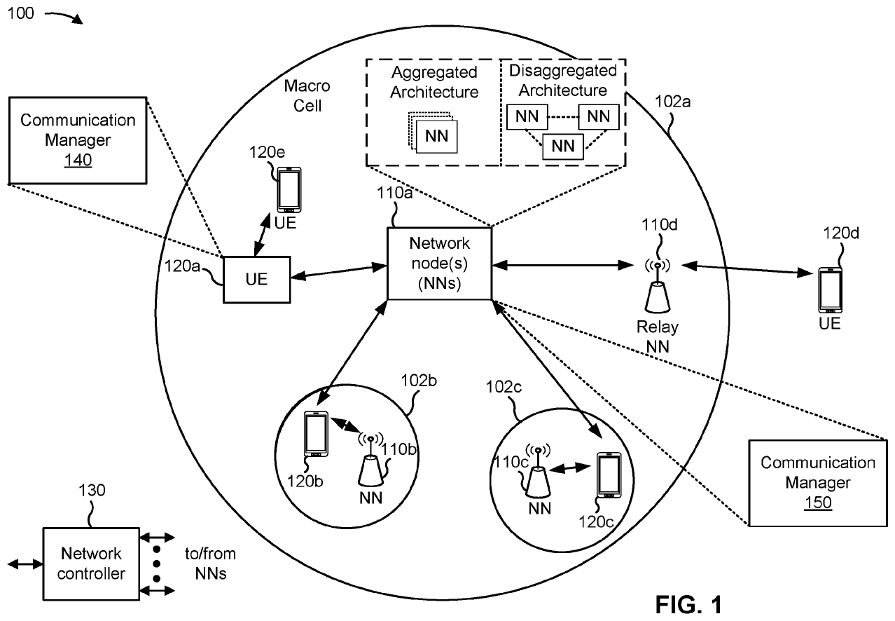

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects. “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases. NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz). FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1. FR2. FR3, FR4. FR4-a. FR4-1, and/or FR5) may be modified, and techniques described herein are applicable to those modified frequency ranges.

In some aspects, the UE 120 may include a communication manager 140. As described in more detail elsewhere herein, the communication manager 140 may obtain information associated with a scaling factor to be applied to a parameter for updating a model; selectively apply the scaling factor to the parameter, based at least in part on a number of training samples associated with the UE, to obtain a scaled parameter; and transmit the scaled parameter to a network node. Additionally. or alternatively, the communication manager 140 may perform one or more other operations described herein.

In some aspects, the network node 110 may include a communication manager 150. As described in more detail elsewhere herein, the communication manager 150 may transmit information to a UE that indicates a scaling factor to be applied to a parameter for updating a model based at least in part on a number of training samples associated with the UE; and receive a scaled parameter from the UE that is based at least in part on the scaling factor and the number of training samples associated with the UE. Additionally. or alternatively, the communication manager 150 may perform one or more other operations described herein.

As indicated above. FIG. 1 is provided as an example. Other examples may differ from what is described with regard to FIG. 1.

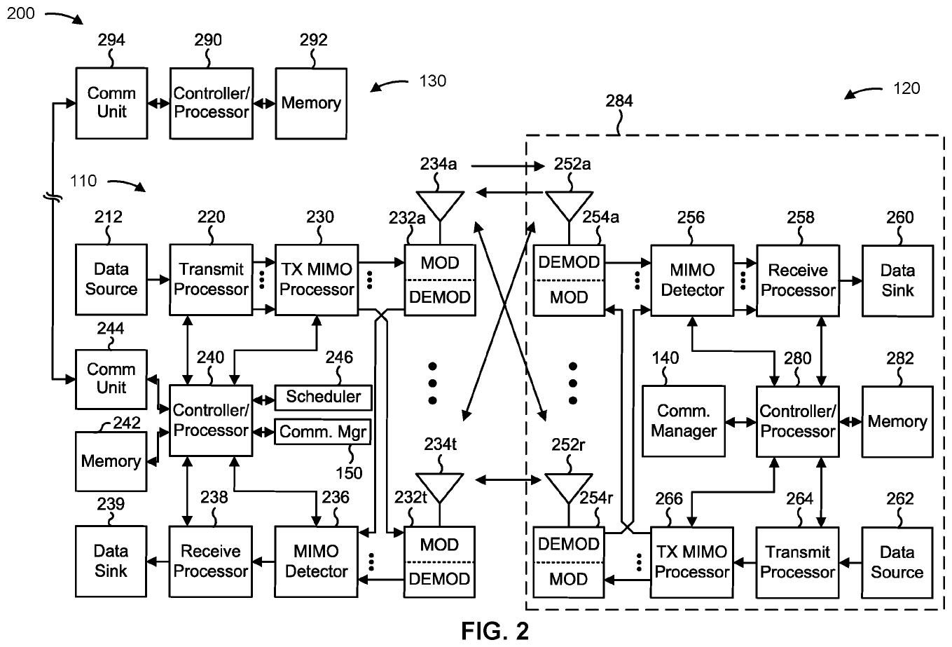

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs. or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g. T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234l.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

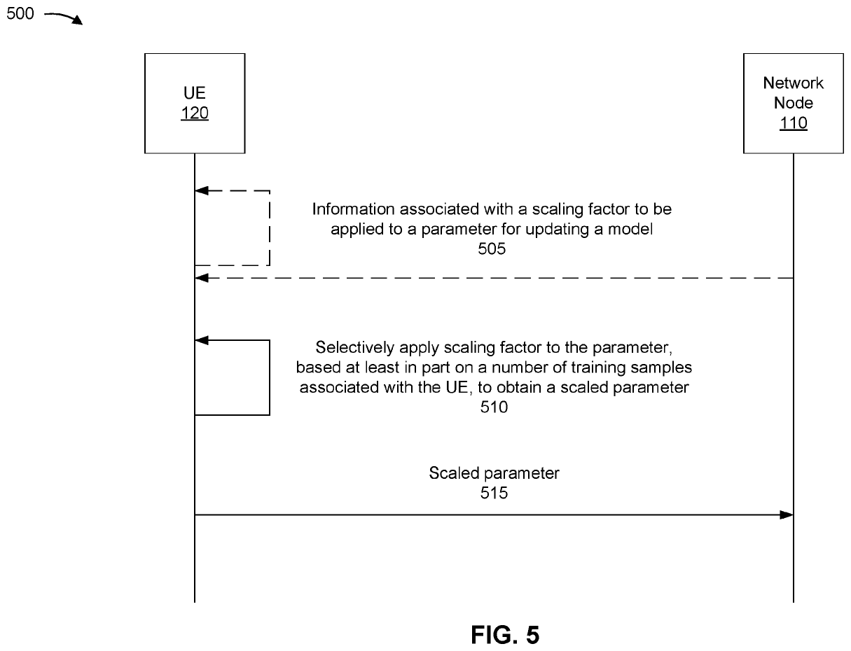

On the uplink, at the UE 120, a transmit processor 264 may receive and process data from a data source 262 and control information (e.g., for reports that include RSRP. RSSI. RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

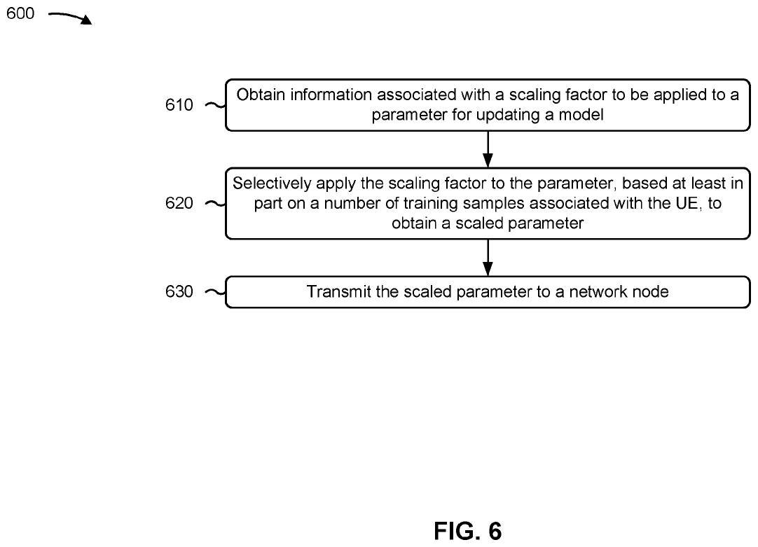

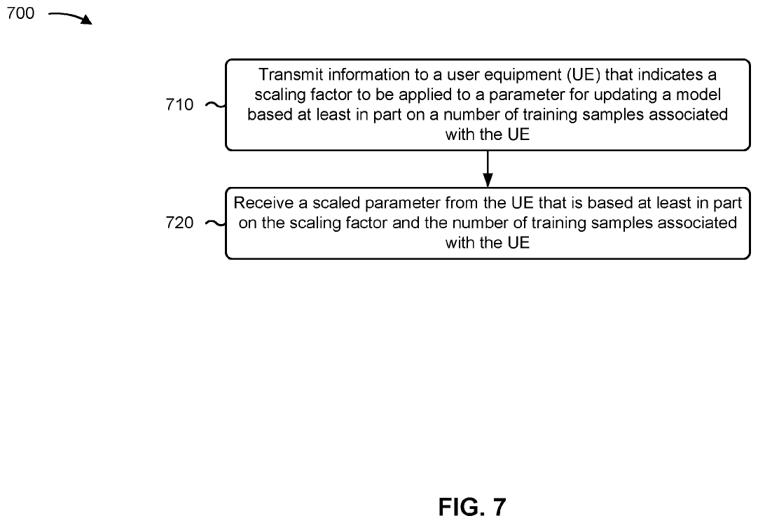

The controller/processor 240 of the network node 110, the controller/processor 280 of the UE 120, and/or any other component(s) of FIG. 2 may perform one or more techniques associated with scaling model parameters, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g. code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE (e.g., the UE 120) includes means for obtaining information associated with a scaling factor to be applied to a parameter for updating a model; means for selectively applying the scaling factor to the parameter, based at least in part on a number of training samples associated with the UE, to obtain a scaled parameter; and/or means for transmitting the scaled parameter to a network node. The means for the UE to perform operations described herein may include, for example, one or more of communication manager 140, antenna 252, modem 254, MIMO detector 256, receive processor 258, transmit processor 264. TX MIMO processor 266, controller/processor 280, or memory 282.

In some aspects, the network node (e.g., the network node 110) includes means for transmitting information to a UE that indicates a scaling factor to be applied to a parameter for updating a model based at least in part on a number of training samples associated with the UE; and/or means for receiving a scaled parameter from the UE that is based at least in part on the scaling factor and the number of training samples associated with the UE. The means for the network node to perform operations described herein may include, for example, one or more of communication manager 150, transmit processor 220. TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs. or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU. DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an LAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

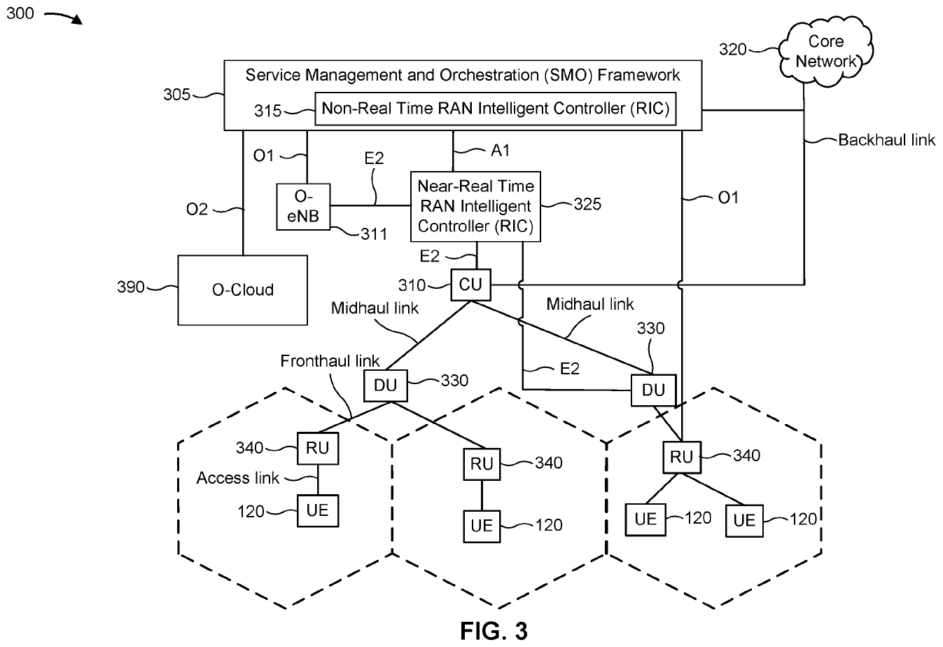

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example. Central Unit-User Plane (CU-UP) functionality), control plane functionality (for example. Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to CUs 310. DUs 330. RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources. Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above. FIG. 3 is provided as an example. Other examples may differ from what is described with regard to FIG. 3.

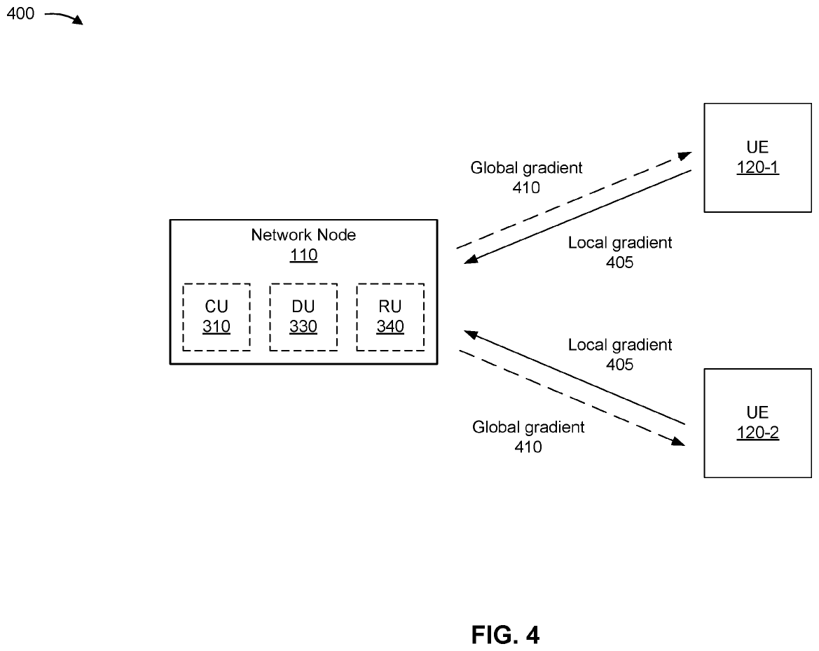

FIG. 4 is a diagram illustrating an example model 400 in accordance with the present disclosure. The network node 110 may communicate with a plurality of UEs 120, such as the UE 120-1 and the UE 120-2. The network node 110 may include some or all of the features of the CU 310, the DU 330, or the RU 340 described herein, among other examples.

In some cases, the model 400 may be a federated learning model. Federated learning may enable multiple UEs 120 (such as the UE 120-1 and the UE 120-2) to be configured with a common model, and to use local computation power to refine the model. In some cases, the federated learning model may be a neural network model. The model may be used for keyword prediction, voice prediction, and/or for predicting future RSRP measurements based at least in part on previous RSRP measurements for different beams in an area, among other examples. The federated learning model may be refined based at least in part on updates to the model. In some cases, different UEs configured with the model may have access to different sets of data that can be used to compute a local update for the model. For example, the UE 120-1 may compute a first local update for the model based at least in part on data that is available to the UE 120-1, and the UE 120-2 may compute a second local update for the model based at least in part on data that is available to the UE 120-2. In some cases, the local update to the model may be a gradient that is determined based at least in part on applying the local data to the model.

Federated learning may enable back-propagation that is computed locally at the edge nodes (e.g., the UE 120-1 and the UE 120-2). In some cases, the UE 120-1 and the UE 120-2 may only transmit the parameter updates to the network node 110 without sending the raw data (e.g., without sending any raw data, or only sending a portion of the raw data). This may result in less overall data traffic and may enhance user privacy.

In some cases, the update to the model may occur in multiple iterations. For example, the UE 120-1 and the UE 120-2 may each compute a local gradient, such as a local gradient 405, for the model using local data, and may send the local gradients to the network node 110. The network node 110 (e.g., the CU 310) may compute a global update to the model, such as a global gradient 410, using the local updates received from the UE 120-1 and the UE 120-2. In some cases, the network node 110 may transmit the global update to each of the UE 120-1 and the UE 120-2. The UE 120-1 and the UE 120-2 may update one or more parameters based at least in part on receiving the global update.

In some cases, the gradient feedback may be digital feedback or may be analog feedback (e.g., OTA feedback). When using digital feedback, each UE 120 may be configured with dedicated resources (e.g., resources that are specific to the respective UE 120) for sending local gradients corresponding to the UE 120. For example, the UE 120-1 may be configured with first resources for sending a local gradient corresponding to the UE 120-1, and the UE 120-2 may be configured with second resources for sending a local gradient corresponding to the UE 120-2. In some cases, each entry of the gradient may be encoded in digital bits as a normal data package. If there are K UEs 120, and the length of the gradient vector is M, the total quantity of resources that are needed to send the gradient vectors from all of the UEs 120 may be K*M. In some cases, because the network node 110 receives the local gradients from each UE 120 using different resources, the network node 110 may be able to determine which UE 120 sent a particular gradient vector.

When using analog feedback, all UEs 120 may use the same resource(s) for sending the local gradients. For example, the UE 120-1 may use a resource for sending the local gradient associated with the UE 120-1, and the UE 120-2 may use the same resource for sending the local gradient associated with the UE 120-2. The resources that are needed for transmitting the gradient feedback may correspond to the length of the gradient vector K (regardless of the quantity of UEs). Thus, analog feedback may use fewer resources than digital feedback. In some cases, an analog waveform may be used to indicate the magnitude of the gradients. For example, the analog waveforms from different UEs 120 may be aggregated over the air, and the network node 110 may receive the aggregated versions of all analog waveforms from the different UEs 120. The aggregation over the air may act as a summation of all local gradients. In such examples, the network node 110 may be able to determine the global gradient vector based at least in part on detecting the aggregated waveform. However, in some cases, the network node 110 may not be able to determine the individual vectors (e.g., the local gradients) associated with each of the respective UEs 120.

As described herein, the network node 110 may perform federated learning based at least in part on data collected or generated by edge devices, such as the UE 120-1 and UE 120-2. In some examples, the network node 110 may be a base station (such as a disaggregated base station), a roadside unit (RSU), an application server, or another network element, among other examples, and the UE 120 may be a smart phone or a vehicle, among other examples. The network node 110 may provide each UE 120 with a copy of the global machine learning model. Each UE 120 may train parameters of the model using data that is local to the respective UE 120. For example, the UE 120-1 may train the model using data that is local to the UE 120-1, and the UE 120-2 may train the model using data that is local to the UE 120-2. The UEs 120 may send the respectively trained parameters to the network node 110, and the network node 110 may aggregate the parameters (e.g., using OTA aggregation). The training of the model and model parameters may occur in an iterative manner over time, such as being performed over multiple rounds of training.

In some cases, transmitting model parameters may require significant overhead. For example, a neural network model may have hundreds of thousands of parameters that need to be trained. In this case, individually transmitting model parameters to the network node 110 may be problematic, particularly when the transmissions occur in a wireless network such as a cellular network. In some cases. OTA aggregation may be used to reduce the network overhead. An example OFDM based system may include N parameters (0, 1 . . . . N−1) and M UEs 120 (0, 1 . . . . M−1). Each model parameter may be mapped to a single resource element. Different UEs associated with the OFDM based system may transmit model parameters in the specified resource element for that parameter. In each UE's OTA signal transmission, the values of parameters may be normalized prior to being transmitted. In one example, the received parameter value for parameter n may be:

$${P}_{n} = {\sum }_{m = 0}^{M - 1} \sqrt{{p}_{n , m}} {e}^{i {ϕ}_{n , m}} ,$$

\sqrt{p_{n,m}} is an amplitude of a received parameter from UE m, and
φ_{n,m} is phase error (caused by fading, among other examples).

In some cases, different UEs associated with the model may have different numbers of training samples for the model. For example, some UEs may have generated and/or collected a higher number of training samples than other UEs. Additionally. or alternatively, a particular UE may have generated and/or collected a higher number of training samples in a current round of model training than in a previous round of model training. In some cases, it may be beneficial for a UE that has collected more training samples to have a greater contribution to updating the model parameters than a UE that has collected fewer training samples. For example, a UE that has collected one hundred training samples may have different (e.g., more accurate) information associated with the updating of the model parameters than a UE that has collected ten training samples. Similarly, it may be beneficial for a UE to have a greater contribution to updating the model parameters during a training round where the UE has collected a larger number of training samples than during a round where the UE has collected a smaller number of training samples. However, current OTA aggregation processes may not enable different contributions to the model parameters by different UEs. and in particular, may not enable different contributions to the model parameters by different UEs based at least in part on the number of training samples generated and/or collected by the different UEs.

Techniques and apparatuses are described herein for scaling model parameters. In some aspects, a UE may obtain information associated with a scaling factor to be applied to a parameter for updating a model, such as a federated learning model. For example, a network node may transmit, and the UE may receive, information that indicates a scaling factor to be applied to a parameter for updating the model based at least in part on a number of training samples associated with the UE. The UE may selectively apply the scaling factor to a parameter, based at least in part on the number of training samples associated with the UE, to obtain a scaled parameter, and may transmit an indication of the scaled parameter to the network node. In some aspects, the scaling factor may be higher when the UE has a larger number of training samples associated with the parameter, and may be lower when the UE has a smaller number of training samples associated with the parameter.

As described above, different UEs associated with the model may have different numbers of training samples for the model. For example, some UEs may have collected a higher number of training samples than other UEs. However, current OTA aggregation processes may not enable different contributions to model parameters by different UEs, and in particular, may not enable different contributions to model parameters by different UEs based at least in part on the number of training samples collected by the different UEs. Using the techniques and apparatuses described herein, a UE that has collected more training samples may have a greater contribution to updating the model parameters than a UE that has collected fewer training samples. Similarly, a UE that has collected more training samples during a current round of model training may have a greater contribution to updating the model parameters than during a previous round where the UE has collected a smaller number of training samples. This may improve the efficiency and accuracy of the model updating, while reducing the overhead in the OTA transmissions. Additional details regarding these features are described herein.

As indicated above. FIG. 4 is provided as an example. Other examples may differ from what is described with regard to FIG. 4.

FIG. 5 is a diagram illustrating an example 500 of scaling model parameters, in accordance with the present disclosure. A UE, such as the UE 120, may communicate with a network node, such as the network node 110. The network node 110 may include some or all of the features of the CU 310, DU 330, or RU 440, among other examples. In some aspects, the network node 110 may be another UE 120 or may include another UE 120. For example, the UE 120 and the network node 110 may communicate via sidelink, such as via a PC5 interface. In some aspects, the network node 110 and the UE 120 may be configured to train a model, such as a federated learning model, having one or more parameters.

As shown by reference number 505, the UE 120 may obtain information associated with a scaling factor to be applied to one or more parameters for updating the model (e.g., the federated learning model). In some aspects, the information associated with the scaling factor may be stored in a memory of the UE 120. In some aspects, the network node 110 may transmit, and the UE 120 may receive, the information associated with the scaling factor. The information associated with the scaling factor may indicate to apply the scaling factor to the one or more model parameters based at least in part on a number of training samples associated with the UE 120. Additional details are described below.

As shown by reference number 510, the UE 120 may selectively apply the scaling factor to the parameter to obtain a scaled parameter. The UE 120 may selectively apply the scaling factor to the parameter based at least in part on the number of training samples associated with the UE 120. In some aspects, the scaling factor may be higher when the UE 120 has a larger number of training samples and may be lower when the UE 120 has a smaller number of training samples. In some aspects, the trained parameters from the UE 120 may be scaled based at least in part on the number of training samples associated with UE 120 (Nₘ) and a total number of training samples from all participating UEs (N_{T}):

$$\frac{{N}_{m}}{{N}_{T}} .$$

However, this may require the UE 120 to be configured with the total number of training samples from all participating UEs (N_{T}), which may result in increased overhead for training of the federated learning model. In some aspects (e.g., in a first example), the UE 120 may be configured with a threshold number of training samples. If the UE 120 is training the model with a number of training samples that does not satisfy the threshold number of training samples, the UE 120 may apply the scaling factor. Otherwise, the UE 120 may not apply the scaling factor. In some aspects (e.g., in a second example), the UE 120 may be configured with a coefficient. An OTA transmission by the UE 120 may be scaled based at least in part on the number of training samples associated with the UE 120 and the coefficient. The coefficient may be a common coefficient that is shared by the UE 120 and one or more other UEs 120 that are using the model. In some aspects (e.g., in a third example), the UE 120 may be configured with a mapping that indicates a plurality of scaling factors that are to be applied by the UE 120 based at least in part on the number of training samples associated with the UE 120. Additional details regarding these features are described below.

In some aspects, such as in the first example described above, the UE 120 may be configured with a threshold number of training samples. The threshold number of training samples may be configured (e.g., pre-configured) in the UE 120 and/or may be received from the network node 110. For example, the network node 110 may transmit an indication of the threshold number of training samples when the network node 110 provides the UE 120 with the training model or an update to the training model. In some aspects, the threshold number of training samples may be application-based and/or model-based. For example, the UE 120 may be configured to use a first number of training samples for a first application or a first iteration of the model and may be configured to use a second number of training samples for a second application or a second iteration of the model. In some aspects, the threshold number of training samples may be based at least in part on an implementation, such as a machine learning application implementation.

In some aspects, the UE 120 may apply the scaling factor based at least in part on the number of training samples associated with the UE 120 not satisfying the threshold number of training samples. For example, the UE 120 may apply the scaling factor based at least in part on the number of training samples generated and/or collected by the UE 120 being less than, or less than or equal to, the threshold number of training samples. In some aspects, the UE 120 may not apply the scaling factor based at least in part on the number of training samples associated with the UE 120 satisfying the threshold number of training samples. For example, the UE 120 may not apply the scaling factor based at least in part on the number of training samples generated and/or collected by the UE 120 being greater than, or greater than or equal to, the threshold number of training samples. The scaling factor may be any value that is less than (or less than or equal to) 1 but greater than (or greater than or equal to) 0. In some aspects, the scaling factor may be fixed, may be pre-determined, and/or may be provided to the UE 120 by the network node 110. In some aspects, the UE 120 may have a number of training samples that is less than the threshold number of training samples based at least in part on a limited processing capability of the UE 120, such as the UE 120 not being able to process a number of training samples that is greater than or equal to the threshold number of training samples within a time period. In some aspects, the UE 120 may be configured with multiple training sample thresholds. For example, the UE 120 may be configured with a second training sample threshold that is associated with a scaling factor of zero. The UE 120 may not transmit the OTA signal based at least in part on the number of training samples generated and/or collected by the UE 120 being less than the second training sample threshold and based at least in part on the UE 120 applying the scaling factor of zero (e.g., multiplying a parameter update value by zero).

In some aspects, such as in the second example described above, the UE 120 may store a coefficient. The coefficient may be a common coefficient that is shared by the UE 120 and one or more other UEs 120 associated with the model. For example, each of the UEs 120 associated with the model may be configured with the common coefficient. In some aspects, the coefficient may be received from the network node 110. For example, the network node 110 may transmit an indication of the coefficient when the network node 110 provides the UE 120 with the training model or an update to the training model. In some aspects, the coefficient may be application-based and/or model-based. For example, the UE 120 may be configured to use a first coefficient for a first application or a first iteration of the model and may be configured to use a second coefficient for a second application or a second iteration of the model. In some aspects, the coefficient may be based at least in part on an implementation, such as a machine learning application implementation.

In some aspects, the UE 120 may use Nᵤ training samples. In this case, the UE 120 may apply a scaling factor of

$$\frac{{N}_{u}}{N}$$

to the model training parameters. Applying the scaling factor may include multiplying a parameter update value for the parameter by the scaling factor. In some aspects. N may be a large number such that

$$\frac{{N}_{u}}{N}$$

is not greater than one. In some aspects, the UE 120 may not be enabled to train the model using more than N samples. For example Nᵤ≤N may be enforced by the UE 120 and/or the network node 110. In some aspects, the UE 120 may use more than N samples to train the model, but a scaling factor may be determined as

$$min ( 1 , \frac{{N}_{u}}{A} ) .$$

uses more than N training samples. For example, if the number of training samples is greater than 1, the UE 120 may use the lesser value of one as the scaling factor. In some aspects, the UE 120 may be configured with multiple coefficients.

In some aspects, such as in the third example described above, the UE 120 may be configured with a mapping that indicates a plurality of scaling factors to be applied to a parameter based at least in part on the number of training samples. For example, the mapping may indicate multiple scaling factors that can be applied by the UE 120 based at least in part on the number of training samples generated and/or collected by the UE 120. The larger the number of training samples, the larger the scaling factor that can be applied by the UE 120. In some aspects, the mapping may be received from the network node 110. For example, the network node 110 may transmit an indication of the mapping when the network node 110 provides the UE 120 with the training model or an update to the training model. In some aspects, a number of mapping tables may be pre-configured in the UE 120 and/or one or more other UEs 120 associated with the model. For example, each machine learning application may have one mapping table specified, and the UE 120 may select the mapping table to be used based at least in part on the machine learning application that is associated with the OTA transmission. In another example, each machine learning application may have multiple mapping tables specified, and the network node 110 may select the mapping table to be used and/or may indicate the mapping table that is to be used to one or more other UEs 120 associated with the model. An example of a mapping table is shown in Table 1 below.

TABLE 1
Mapping Table

| Number of training samples | Scaling factor |
|---|---|
| N ≥ N1 | 1.0 |
| N1 > N ≥ N2 | 0.5 |
| N2 > N ≥ N3 | 0.25 |
| N < N3 | 0.0 |

In some aspects, the gain of training using more than N1 samples may be limited (e.g., due to larger training error or overtraining, among other examples) and may therefore be capped at N1. In this case, the UE 120 may only train the model using N1 samples, even though the UE 120 may have generated and/or collected more than N1 samples. Additionally. or alternatively, when the number of samples is below a certain value (such as N3), contribution from training the model using the samples may be limited or may be zero. In this case, the UE 120 may not transmit the OTA parameters. Table 1 is provided as an example only. For example, different threshold values and/or different numbers of thresholds may be indicated. In some aspects, the scaling factor may be linearly related to the number of training samples (as shown in the table) or may be logarithmically related to the number of training samples. For example N1 may be 0 decibels (dB) and N2 may be −3 dB.

In some aspects, the scaling factor may be based at least in part on a machine learning capability of the UE 120. For example, the number of iterations (e.g., model updating iterations) that the UE 120 is capable of performing may be based at least in part on a gradient descent algorithm. In this case, the more iterations that are performed by the UE 120, the smaller the training error. In some aspects, the UEs 120 participating in the model may be required to perform the same number of iterations and/or at least the same minimum number of iterations. Additionally. or alternatively, the UEs 120 participating in the model may perform a number of iterations that is based at least in part on a computational capability of the respective UE 120 (within a delay budget). For example, a higher-tier smart phone may have greater machine learning capabilities than a lower-tier smart phone. In some aspects, the scaling factor may be applied to an OTA transmission based at least in part on the number of iterations performed by the UE 120 not satisfying an iteration threshold. Additionally, or alternatively, the UE 120 may apply different scaling factors based at least in part on different numbers of iterations performed by the UE 120. In some aspects, both capability-based scaling and training sample-based scaling may be applied to the model updating by the UE 120. In this case, the UE 120 may determine the scaling factor based at least in part on a machine learning capability of the UE 120 and a number of training samples generated and/or collected by the UE 120. In some aspects, the UE 120 may multiple two (or more) scaling factors during respective OTA parameter transmissions. Additionally, or alternatively, a joint mapping may indicate a scaling factor to be applied to an OTA transmission based at least in part on the number of training samples associated with the UE 120 and the machine learning capability of the UE 120.

In some aspects, the network node 110 may indicate for the UE 120 to enable or disable applying the scaling factor to the model parameters based at least in part on the number of training samples. In some aspects, the network node 110 may indicate for the UE 120 to enable the scaling factor for some applications of the model and to disable the scaling factor for other applications of the model. In some aspects, the network node 110 may indicate one or more methods for applying the scaling factor to the model parameters. For example, the network node 110 may indicate for the UE 120 to apply the scaling factor in accordance with the first example, the second example, or the third example described above, among other examples. In some aspects, the scaling factor may be applied to radio link based signaling and/or to sidelink based signaling. For example, the network node 110 may be disaggregated base station, a portion of the disaggregated base station, or may be another UE 120, among other examples. In radio link (e.g., Uu) based communications, the UE 120 may transmit OTA signals in uplink to the network node 110, and may apply the power scaling in the uplink OTA transmission. In sidelink (e.g., PC5) based communications, the UE 120 may transmit an OTA signal in sidelink to the network node 110 (or another UE 120), and may apply the scaling factor in the sidelink OTA transmission. In some aspects, the scaling factor may be applied as an energy per resource element (EPRE) scaling. The EPRE scaling may be performed prior to a power control operation. Alternatively, the EPRE scaling may be applied together with the power control operation (for example, regular power control may be needed to inverse dependent fading, such as pathloss).

As shown by reference number 515, the UE 120 may transmit, and the network node 110 may receive, the scaled parameter. In some aspects, the UE 120 may apply the scaling factor to one or more of the model parameters using any of the first example, the second example, and/or the third example to generate the scaled parameter, and may transmit the scaled parameter(s) to the network node 110.

As described above, different UEs associated with the model may have different numbers of training samples for the model. For example, some UEs may have collected a higher number of training samples than other UEs. However, current OTA aggregation processes may not enable different contributions to model parameters by different UEs, and in particular, may not enable different contributions to model parameters by different UEs based at least in part on the number of training samples collected by the different UEs. Using the techniques and apparatuses described herein, a UE that has collected more training samples may have a greater contribution to updating the model parameters than a UE that has collected fewer training samples. Similarly, a UE that has collected more training samples during a current round of model training may have a greater contribution to updating the model parameters than during a previous round where the UE has collected a smaller number of training samples. This may improve the efficiency and accuracy of the model updating, while reducing the overhead in the OTA transmissions.

As indicated above. FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with scaling model parameters.

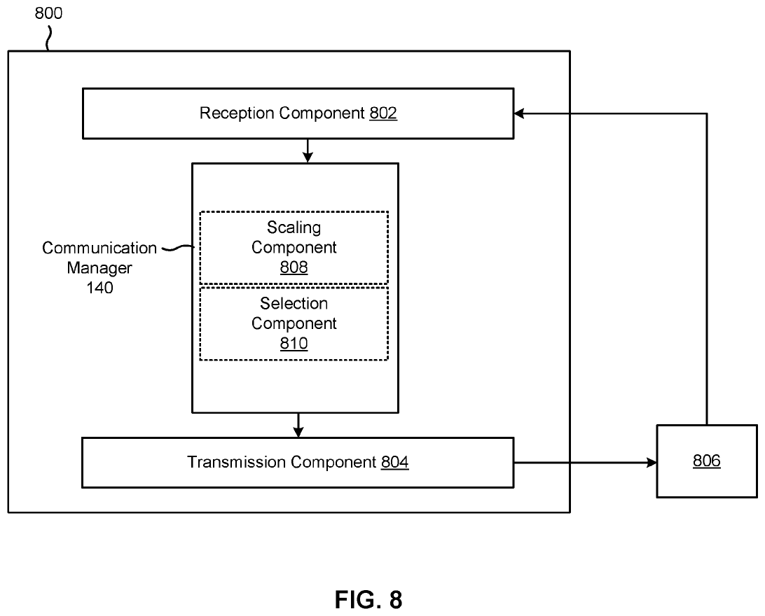

As shown in FIG. 6, in some aspects, process 600 may include obtaining information associated with a scaling factor to be applied to a parameter for updating a model (block 610). For example, the UE (e.g., using communication manager 140 and/or scaling component 808, depicted in FIG. 8) may obtain information associated with a scaling factor to be applied to a parameter for updating a model, as described above.

As further shown in FIG. 6, in some aspects, process 600 may include selectively applying the scaling factor to the parameter, based at least in part on a number of training samples associated with the UE, to obtain a scaled parameter (block 620). For example, the UE (e.g., using communication manager 140 and/or selection component 810, depicted in FIG. 8) may selectively apply the scaling factor to the parameter, based at least in part on a number of training samples associated with the UE, to obtain a scaled parameter, as described above.

As further shown in FIG. 6, in some aspects, process 600 may include transmitting the scaled parameter to a network node (block 630). For example, the UE (e.g., using communication manager 140 and/or transmission component 804, depicted in FIG. 8) may transmit the scaled parameter to a network node, as described above.

Process 600 may include additional aspects, such as any single aspect or any combination of aspects described below and/or in connection with one or more other processes described elsewhere herein.

In a first aspect, the information associated with the scaling factor indicates to apply the scaling factor based at least in part on the number of training samples associated with the UE not satisfying a training sample threshold, and wherein selectively applying the scaling factor to the parameter comprises applying the scaling factor to the parameter based at least in part on the number of training samples associated with the UE not satisfying the training sample threshold.

In a second aspect, alone or in combination with the first aspect, the training sample threshold includes a first training sample threshold to be used for a first application or a first iteration of the model and a second training sample threshold to be used for a second application or a second iteration of the model.

In a third aspect, alone or in combination with one or more of the first and second aspects, the scaling factor to be applied to the parameter is a first scaling factor, and the information associated with the first scaling factor further indicates to apply a second scaling factor to the parameter based at least in part on the number of training samples not satisfying a second training sample threshold.

In a fourth aspect, alone or in combination with one or more of the first through third aspects, the second scaling factor is zero.

In a fifth aspect, alone or in combination with one or more of the first through fourth aspects, the scaling factor is a coefficient that is to be applied to the parameter for updating the model by the UE and one or more other UEs associated with the model.

In a sixth aspect, alone or in combination with one or more of the first through fifth aspects, the coefficient includes a first coefficient to be used for a first application or a first iteration of the model and a second coefficient to be used for a second application or a second iteration of the model.

In a seventh aspect, alone or in combination with one or more of the first through sixth aspects, selectively applying the scaling factor to the parameter to obtain the scaled parameter comprises dividing the number of training samples associated with the UE by the coefficient.

In an eighth aspect, alone or in combination with one or more of the first through seventh aspects, the scaling factor has a value that is greater than zero but less than one.

In a ninth aspect, alone or in combination with one or more of the first through eighth aspects, the number of training samples associated with the UE is less than or equal to the coefficient.

In a tenth aspect, alone or in combination with one or more of the first through ninth aspects, the information associated with the scaling factor indicates to apply another coefficient to the parameter based at least in part on the number of training samples not satisfying a training sample threshold.

In an eleventh aspect, alone or in combination with one or more of the first through tenth aspects, the information associated with the scaling factor indicates a mapping between the scaling factor and the number of training samples associated with the UE.

In a twelfth aspect, alone or in combination with one or more of the first through eleventh aspects, information associated with the scaling factor indicates to apply a first scaling factor based at least in part on the number of training samples satisfying a first threshold, a second scaling factor based at least in part on the number of training samples not satisfying a second threshold, or a third scaling factor based at least in part on the number of training samples being less than the first threshold but greater than the second threshold.

In a thirteenth aspect, alone or in combination with one or more of the first through twelfth aspects, receiving the information associated with the scaling factor comprises receiving configuration information from the network node that includes an indication of the scaling factor.

In a fourteenth aspect, alone or in combination with one or more of the first through thirteenth aspects, receiving the configuration information from the network node comprises receiving an indication of the model, or an indication of an update to the model, that includes the configuration information.

In a fifteenth aspect, alone or in combination with one or more of the first through fourteenth aspects, selectively applying the scaling factor to the parameter comprises selectively applying the scaling factor to the parameter based at least in part on the number of training samples and a machine learning capability of the UE.

In a sixteenth aspect, alone or in combination with one or more of the first through fifteenth aspects, the model is a federated learning model and the parameter includes one or more gradient updates to the model.

Although FIG. 6 shows example blocks of process 600, in some aspects, process 600 may include additional blocks, fewer blocks, different blocks, or differently arranged blocks than those depicted in FIG. 6. Additionally. or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with scaling model parameters.

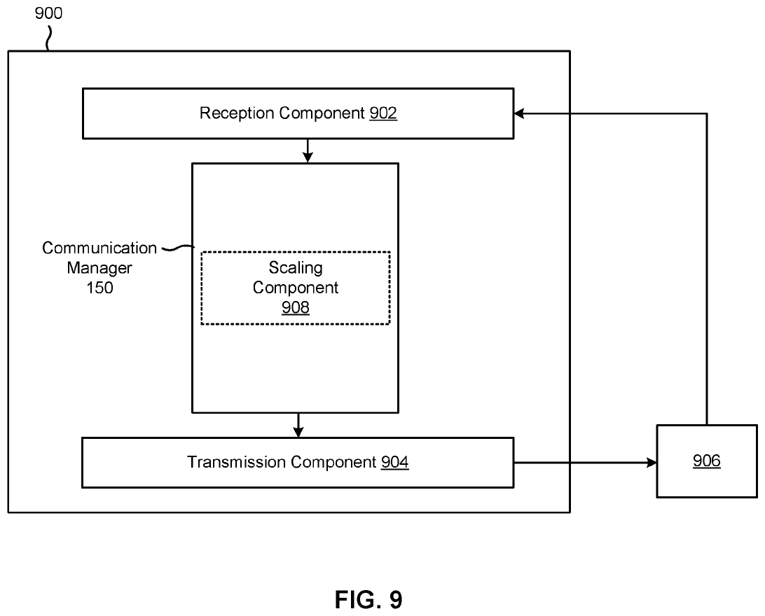

As shown in FIG. 7, in some aspects, process 700 may include transmitting information to a UE that indicates a scaling factor to be applied to a parameter for updating a model based at least in part on a number of training samples associated with the UE (block 710). For example, the network node (e.g., using communication manager 150 transmission component 904, and/or scaling component 908, depicted in FIG. 9) may transmit information to a UE that indicates a scaling factor to be applied to a parameter for updating a model based at least in part on a number of training samples associated with the UE, as described above.

As further shown in FIG. 7, in some aspects, process 700 may include receiving a scaled parameter from the UE that is based at least in part on the scaling factor and the number of training samples associated with the UE (block 720). For example, the network node (e.g., using communication manager 150 and/or reception component 902, depicted in FIG. 9) may receive a scaled parameter from the UE that is based at least in part on the scaling factor and the number of training samples associated with the UE, as described above.

Process 700 may include additional aspects, such as any single aspect or any combination of aspects described below and/or in connection with one or more other processes described elsewhere herein.

In a first aspect, receiving the scaled parameter from the UE comprises receiving a plurality of scaled parameters from a plurality of respective UEs and calculating an over-the-air aggregation of the plurality of scaled parameters.

In a second aspect, alone or in combination with the first aspect, transmitting the information to the UE that indicates the scaling factor comprises transmitting information to a plurality of UEs that indicates a common scaling factor to be applied to the parameter for updating the model based at least in part on a number of training samples associated with a respective UE of the plurality of UEs.

In a third aspect, alone or in combination with one or more of the first and second aspects, the information that indicates the scaling factor indicates to apply the scaling factor based at least in part on the number of training samples associated with the UE not satisfying a training sample threshold.

In a fourth aspect, alone or in combination with one or more of the first through third aspects, the training sample threshold includes a first training sample threshold to be used for a first application or a first iteration of the model and a second training sample threshold to be used for a second application or a second iteration of the model.

In a fifth aspect, alone or in combination with one or more of the first through fourth aspects, the scaling factor is a coefficient that is to be applied to the parameter for updating the model by the UE and one or more other UEs associated with the model.

In a sixth aspect, alone or in combination with one or more of the first through fifth aspects, the information that indicates the scaling factor indicates for the UE to divide the number of training samples associated with the UE by the coefficient.

In a seventh aspect, alone or in combination with one or more of the first through sixth aspects, the information that indicates the scaling factor indicates a mapping between the scaling factor and the number of training samples associated with the UE.

In an eighth aspect, alone or in combination with one or more of the first through seventh aspects, information that indicates the scaling factor indicates to apply a first scaling factor based at least in part on the number of training samples satisfying a first threshold, a second scaling factor based at least in part on the number of training samples not satisfying a second threshold, or a third scaling factor based at least in part on the number of training samples being less than the first threshold but greater than the second threshold.

Although FIG. 7 shows example blocks of process 700, in some aspects, process 700 may include additional blocks, fewer blocks, different blocks, or differently arranged blocks than those depicted in FIG. 7. Additionally. or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a scaling component 808 or a selection component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The scaling component 808 may obtain information associated with a scaling factor to be applied to a parameter for updating a model. The selection component 810 may selectively apply the scaling factor to the parameter, based at least in part on a number of training samples associated with the UE, to obtain a scaled parameter. The transmission component 804 may transmit the scaled parameter to a network node.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally. or alternatively, a set of (one or more) components shown in FIG. 8 may perform one or more functions described as being performed by another set of components shown in FIG. 8.

FIG. 9 is a diagram of an example apparatus 900 for wireless communication in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a scaling component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The transmission component 904 and/or the scaling component 908 may transmit information to a UE that indicates a scaling factor to be applied to a parameter for updating a model based at least in part on a number of training samples associated with the UE. The reception component 902 may receive a scaled parameter from the UE that is based at least in part on the scaling factor and the number of training samples associated with the UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: obtaining information associated with a scaling factor to be applied to a parameter for updating a model; selectively applying the scaling factor to the parameter, based at least in part on a number of training samples associated with the UE, to obtain a scaled parameter; and transmitting the scaled parameter to a network node.

Aspect 2: The method of Aspect 1, wherein the information associated with the scaling factor indicates to apply the scaling factor based at least in part on the number of training samples associated with the UE not satisfying a training sample threshold, and wherein selectively applying the scaling factor to the parameter comprises applying the scaling factor to the parameter based at least in part on the number of training samples associated with the UE not satisfying the training sample threshold.

Aspect 3: The method of Aspect 2, wherein the training sample threshold includes a first training sample threshold to be used for a first application or a first iteration of the model and a second training sample threshold to be used for a second application or a second iteration of the model.

Aspect 4: The method of Aspect 2, wherein the scaling factor to be applied to the parameter is a first scaling factor, and wherein the information associated with the first scaling factor further indicates to apply a second scaling factor to the parameter based at least in part on the number of training samples not satisfying a second training sample threshold.

Aspect 5: The method of Aspect 4, wherein the second scaling factor is zero.

Aspect 6: The method of any of Aspects 1-5, wherein the scaling factor is a coefficient that is to be applied to the parameter for updating the model by the UE and one or more other UEs associated with the model.

Aspect 7: The method of Aspect 6, wherein the coefficient includes a first coefficient to be used for a first application or a first iteration of the model and a second coefficient to be used for a second application or a second iteration of the model.

Aspect 8: The method of Aspect 6, wherein selectively applying the scaling factor to the parameter to obtain the scaled parameter comprises dividing the number of training samples associated with the UE by the coefficient.

Aspect 9: The method of Aspect 8, wherein the scaling factor has a value that is greater than zero but less than one.

Aspect 10: The method of Aspect 8, wherein the number of training samples associated with the UE is less than or equal to the coefficient.

Aspect 11: The method of Aspect 6, wherein the information associated with the scaling factor indicates to apply another coefficient to the parameter based at least in part on the number of training samples not satisfying a training sample threshold.

Aspect 12: The method of any of Aspects 1-11, wherein the information associated with the scaling factor indicates a mapping between the scaling factor and the number of training samples associated with the UE.

Aspect 13: The method of Aspect 12, wherein information associated with the scaling factor indicates to apply a first scaling factor based at least in part on the number of training samples satisfying a first threshold, a second scaling factor based at least in part on the number of training samples not satisfying a second threshold, or a third scaling factor based at least in part on the number of training samples being less than the first threshold but greater than the second threshold.

Aspect 14: The method of any of Aspects 1-13, wherein receiving the information associated with the scaling factor comprises receiving configuration information from the network node that includes an indication of the scaling factor.

Aspect 15: The method of Aspect 14, wherein receiving the configuration information from the network node comprises receiving an indication of the model, or an indication of an update to the model, that includes the configuration information.

Aspect 16: The method of any of Aspects 1-15, wherein selectively applying the scaling factor to the parameter comprises selectively applying the scaling factor to the parameter based at least in part on the number of training samples and a machine learning capability of the UE.

Aspect 17: The method of any of Aspects 1-16, wherein the model is a federated learning model and the parameter includes one or more gradient updates to the model.

Aspect 18: A method of wireless communication performed by a network node, comprising: transmitting information to a user equipment (UE) that indicates a scaling factor to be applied to a parameter for updating a model based at least in part on a number of training samples associated with the UE; and receiving a scaled parameter from the UE that is based at least in part on the scaling factor and the number of training samples associated with the UE.

Aspect 19: The method of Aspect 18, wherein receiving the scaled parameter from the UE comprises receiving a plurality of scaled parameters from a plurality of respective UEs and calculating an over-the-air aggregation of the plurality of scaled parameters.

Aspect 20: The method of any of Aspects 18-19, wherein transmitting the information to the UE that indicates the scaling factor comprises transmitting information to a plurality of UEs that indicates a common scaling factor to be applied to the parameter for updating the model based at least in part on a number of training samples associated with a respective UE of the plurality of UEs.

Aspect 21: The method of any of Aspects 18-20, wherein the information that indicates the scaling factor indicates to apply the scaling factor based at least in part on the number of training samples associated with the UE not satisfying a training sample threshold.

Aspect 22: The method of Aspect 21, wherein the training sample threshold includes a first training sample threshold to be used for a first application or a first iteration of the model and a second training sample threshold to be used for a second application or a second iteration of the model.

Aspect 23: The method of any of Aspects 18-22, wherein the scaling factor is a coefficient that is to be applied to the parameter for updating the model by the UE and one or more other UEs associated with the model.

Aspect 24: The method of Aspect 23, wherein the information that indicates the scaling factor indicates for the UE to divide the number of training samples associated with the UE by the coefficient.

Aspect 25: The method of any of Aspects 18-24, wherein the information that indicates the scaling factor indicates a mapping between the scaling factor and the number of training samples associated with the UE.

Aspect 26: The method of Aspect 25, wherein information that indicates the scaling factor indicates to apply a first scaling factor based at least in part on the number of training samples satisfying a first threshold, a second scaling factor based at least in part on the number of training samples not satisfying a second threshold, or a third scaling factor based at least in part on the number of training samples being less than the first threshold but greater than the second threshold.

Aspect 27: An apparatus for wireless communication at a device, comprising a processor; memory coupled with the processor; and instructions stored in the memory and executable by the processor to cause the apparatus to perform the method of one or more of Aspects 1-17.

Aspect 28: A device for wireless communication, comprising a memory and one or more processors coupled to the memory, the one or more processors configured to perform the method of one or more of Aspects 1-17.

Aspect 29: An apparatus for wireless communication, comprising at least one means for performing the method of one or more of Aspects 1-17.

Aspect 30: A non-transitory computer-readable medium storing code for wireless communication, the code comprising instructions executable by a processor to perform the method of one or more of Aspects 1-17.

Aspect 31: A non-transitory computer-readable medium storing a set of instructions for wireless communication, the set of instructions comprising one or more instructions that, when executed by one or more processors of a device, cause the device to perform the method of one or more of Aspects 1-17.

Aspect 32: An apparatus for wireless communication at a device, comprising a processor; memory coupled with the processor; and instructions stored in the memory and executable by the processor to cause the apparatus to perform the method of one or more of Aspects 18-26.

Aspect 33: A device for wireless communication, comprising a memory and one or more processors coupled to the memory, the one or more processors configured to perform the method of one or more of Aspects 18-26.

Aspect 34: An apparatus for wireless communication, comprising at least one means for performing the method of one or more of Aspects 18-26.

Aspect 35: A non-transitory computer-readable medium storing code for wireless communication, the code comprising instructions executable by a processor to perform the method of one or more of Aspects 18-26.

Aspect 36: A non-transitory computer-readable medium storing a set of instructions for wireless communication, the set of instructions comprising one or more instructions that, when executed by one or more processors of a device, cause the device to perform the method of one or more of Aspects 18-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein. “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having.” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, coupled to the one or more memories, configured to:
obtain information associated with a scaling factor to be applied to a parameter for updating a model;
selectively apply the scaling factor to the parameter, based at least in part on a number of training samples associated with the UE, to obtain a scaled parameter; and
transmit the scaled parameter to a network node.

2. The apparatus of claim 1, wherein the information associated with the scaling factor indicates to apply the scaling factor based at least in part on the number of training samples associated with the UE not satisfying a training sample threshold, and wherein selectively applying the scaling factor to the parameter comprises applying the scaling factor to the parameter based at least in part on the number of training samples associated with the UE not satisfying the training sample threshold.

3. The apparatus of claim 2, wherein the training sample threshold includes a first training sample threshold to be used for a first application or a first iteration of the model and a second training sample threshold to be used for a second application or a second iteration of the model.

4. The apparatus of claim 2, wherein the scaling factor to be applied to the parameter is a first scaling factor, and wherein the information associated with the first scaling factor further indicates to apply a second scaling factor to the parameter based at least in part on the number of training samples not satisfying a second training sample threshold.

5. The apparatus of claim 4, wherein the second scaling factor is zero.

6. The apparatus of claim 1, wherein the scaling factor is a coefficient that is to be applied to the parameter for updating the model by the UE and one or more other UEs associated with the model.

7. The apparatus of claim 6, wherein the coefficient includes a first coefficient to be used for a first application or a first iteration of the model and a second coefficient to be used for a second application or a second iteration of the model.

8. The apparatus of claim 6, wherein the one or more processors, to selectively apply the scaling factor to the parameter to obtain the scaled parameter, are configured to divide the number of training samples associated with the UE by the coefficient.

9. The apparatus of claim 8, wherein the scaling factor has a value that is greater than zero but less than one.

10. The apparatus of claim 8, wherein the number of training samples associated with the UE is less than or equal to the coefficient.

11. The apparatus of claim 6, wherein the information associated with the scaling factor indicates to apply another coefficient to the parameter based at least in part on the number of training samples not satisfying a training sample threshold.

12. The apparatus of claim 1, wherein the information associated with the scaling factor indicates a mapping between the scaling factor and the number of training samples associated with the UE.

13. The apparatus of claim 12, wherein information associated with the scaling factor indicates to apply a first scaling factor based at least in part on the number of training samples satisfying a first threshold, a second scaling factor based at least in part on the number of training samples not satisfying a second threshold, or a third scaling factor based at least in part on the number of training samples being less than the first threshold but greater than the second threshold.

14. The apparatus of claim 1, wherein the one or more processors, to receive the information associated with the scaling factor, are configured to receive configuration information from the network node that includes an indication of the scaling factor.

15. The apparatus of claim 14, wherein the one or more processors, to receive the configuration information from the network node, are configured to receive an indication of the model, or an indication of an update to the model, that includes the configuration information.

16. The apparatus of claim 1, wherein the one or more processors, to selectively apply the scaling factor to the parameter, are configured to selectively apply the scaling factor to the parameter based at least in part on the number of training samples and a machine learning capability of the UE.

17. The apparatus of claim 1, wherein the model is a federated learning model and the parameter includes one or more gradient updates to the model.

18. An apparatus for wireless communication at a network node, comprising:
one or more memories; and
one or more processors, coupled to the one or more memories, configured to:
transmit information to a user equipment (UE) that indicates a scaling factor to be applied to a parameter for updating a model based at least in part on a number of training samples associated with the UE; and
receive a scaled parameter from the UE that is based at least in part on the scaling factor and the number of training samples associated with the UE.

19. The apparatus of claim 18, wherein the one or more processors, to receive the scaled parameter from the UE, are configured to receive a plurality of scaled parameters from a plurality of respective UEs and calculating an over-the-air aggregation of the plurality of scaled parameters.

20.-26. (canceled)

27. A method of wireless communication performed by a user equipment (UE), comprising:
obtaining information associated with a scaling factor to be applied to a parameter for updating a model;
selectively applying the scaling factor to the parameter, based at least in part on a number of training samples associated with the UE, to obtain a scaled parameter; and transmitting the scaled parameter to a network node.

28.-30. (canceled)
